(19) United States
(12) Patent Application Publication
(10) Pub. No.: US 2007/0151676 A1
(43) Pub. Date: Jul. 5, 2007

(54) Blind tension means actuated by pushing a push button

(76) Inventor: Henry Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/324,405

(22) Filed: Jan. 4, 2006

(51) Int. Cl. E06B 9/30

(52) U.S. Cl. 160/170

(57) ABSTRACT

A blind includes tension means in a bottom rail and including an output drum, a storage drum, and two cord reels at both sides all being meshed together in gears, an S-shaped tape spring interconnected the output drum and the storage drum, two lines interconnected a head rail and the bottom rail by passing a sheet of drapery material, a portion of the line being wound on the cord reels, and a trigger mechanism including a push button and a spring biased lock member adapted to move either lockingly engage with both the output drum and the storage drum by pressing the push button or not for winding or unwinding the lines to raise or lower the sheet of drapery material. The sheet of drapery material may stay at any desired position after stopping pressing the push button.

### BACKGROUND OF THE INVENTION

1. Field of Invention

The present invention relates to blinds and more particularly to a blind (e.g., folding blind) having a tension means being capable of actuating by pushing a push button for raising or lower the blind.

2. Related Art

Conventionally, a blind (e.g., roll-up or Venetian blind) is adapted to raise or lower by pulling a lift cord coupled to a winding mechanism. However, it is possible that a child may tie the exposed cord about the neck to cause danger or even death. Thus, this is an unsafe design.

A conventional roll-up blind without a lift cord is shown in FIG. 1 and comprises a head rail 1 fixed to a top of window frame, two spaced, opposite springs 2 in the head rail 1, a bottom stiffener strip 3, a plurality of folds 4 coupled between the head rail 1 and the stiffener strip 3, each fold 4 having two orifices proximate both sides, two side rails 5 and 6 fixed at both sides of the window frame, the side rails 5 and 6 adapted to allow both ends of the folds 4 to longitudinally slide therein, and two lines 7 and 8 in which the line 7 has one end passed the right orifices to couple to the right spring 2 and the other end tied off at the left side rail 5 after passing the stiffener strip 3, and the line 8 has one end passed the left orifices to couple to the left spring 2 and the other end tied off at the right side rail 6 after passing the stiffener strip 3.

However, the well known design suffered from several disadvantages in spite of solving the problem of exposed lift cord. For example, the springs 2 tend to lose its elasticity after a predetermined times of lowering or raising operation of the folds 4. And in turn, it may compromise the positioning capability of the folds 4 by operating the lines 7 and 8, resulting in a shortening of a useful life of the blind. Thus, the need for improvement still exists.

### SUMMARY OF THE INVENTION

It is therefore an object of the present invention to provide a blind having a tension means for providing a counterbalancing force or tension such that it is possible of raising or lower the blind by pushing a push button of the tension means.

It is another object of the present invention to provide a blind having a trigger mechanism adapted to operate to enable the blind to stay at any one of a plurality of positions from a fully raised position to a fully lowered position.

To achieve the above and other objects, the present invention provides a blind comprising a head rail; a bottom rail; a sheet of drapery material coupled between the head rail and the bottom rail; tension means provided in the bottom rail and including an intermediate output drum, an intermediate storage drum, a first cord reel at one side proximate the output drum, a second cord reel at the other sides proximate the storage drum, and an S-shaped tape spring interconnected the output drum and the storage drum for providing a counterbalancing force or tension; a couple of lines either interconnected the head rail and the bottom rail by passing the sheet of drapery material wherein a portion of either line is wound on either cord reel; and a trigger mechanism provided in the bottom rail and including a lock member disposed between the output drum and the storage drum, the lock member being adapted to move either in a first direction to engage with both the output drum and the storage drum for locking the output drum, the storage drum, and the first and second cord reels or in a second direction opposite the first direction to disengage with both the output drum and the storage drum for permitting the output drum, the storage drum, and the first and second cord reels to turn for either winding the lines to raise the sheet of drapery material or unwinding the lines to lower the sheet of drapery material.

The above and other objects, features and advantages of the present invention will become apparent from the following detailed description taken with the accompanying drawings.

### BRIEF DESCRIPTION OF THE DRAWINGS

FIG. 1 is a front view of a conventional roll-up blind;

FIG. 2 is a perspective view of a blind incorporating a preferred embodiment of tension means according to the invention where the blind is in its fully folded state;

FIG. 3 is a view similar to FIG. 2 where the blind is in its partially folded state;

FIG. 4 is a perspective view of the bottom rail in part section;

FIG. 5 is an exploded view of the tension means;

FIG. 6 is a front view of the assembled tension means;

FIGS. 7, 8, and 9 are sectional views taken along lines 7-7, 8-8, and 9-9 of FIG. 6 respectively; and

FIG. 10 is a view similar to FIG. 9 where the lock member is disengaged with both the output drum and the storage drum after pushing the push button.

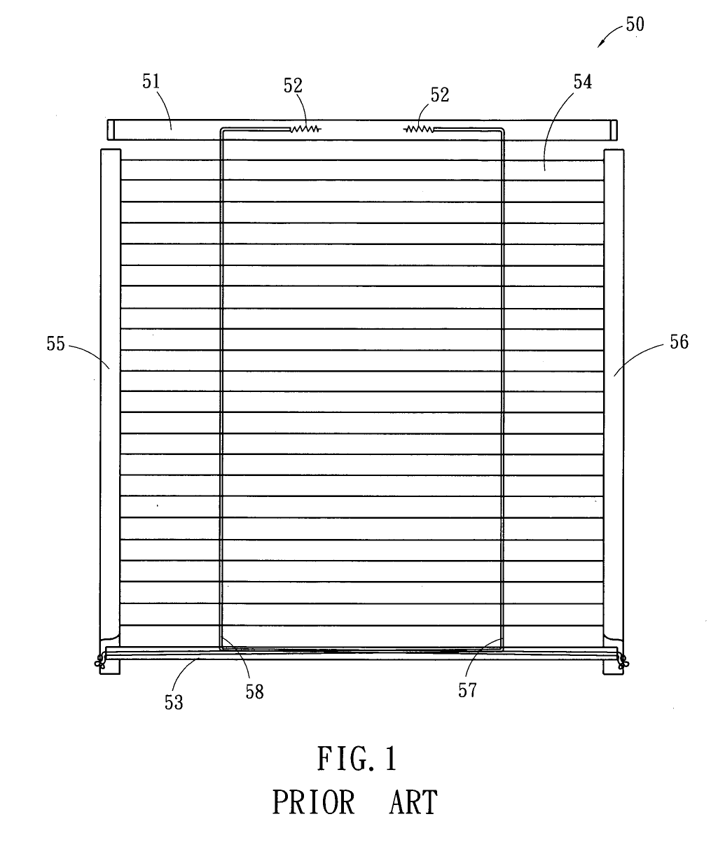

### DETAILED DESCRIPTION OF THE INVENTION

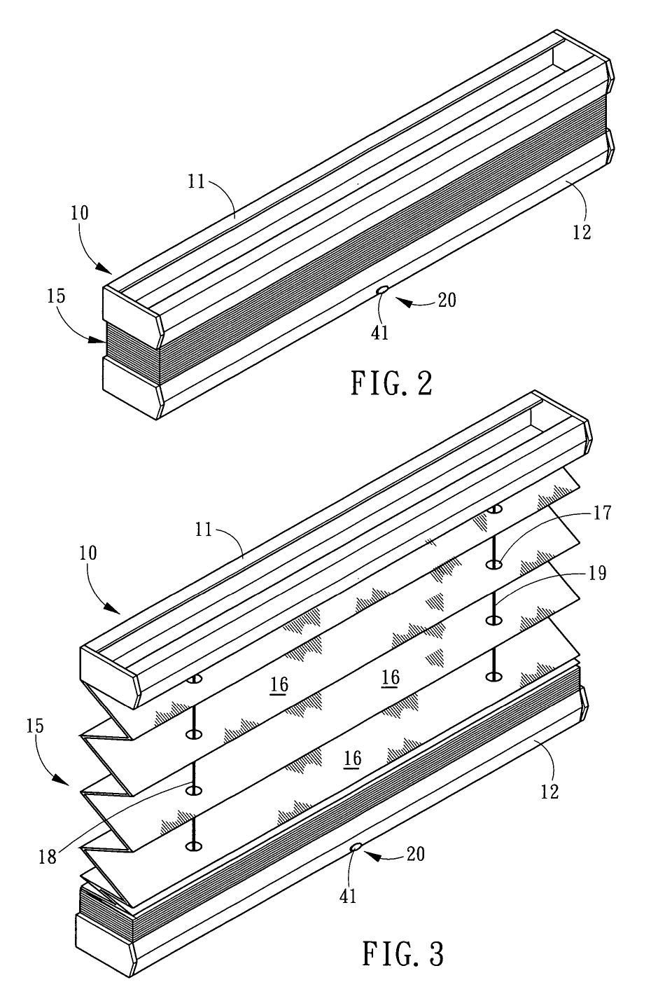

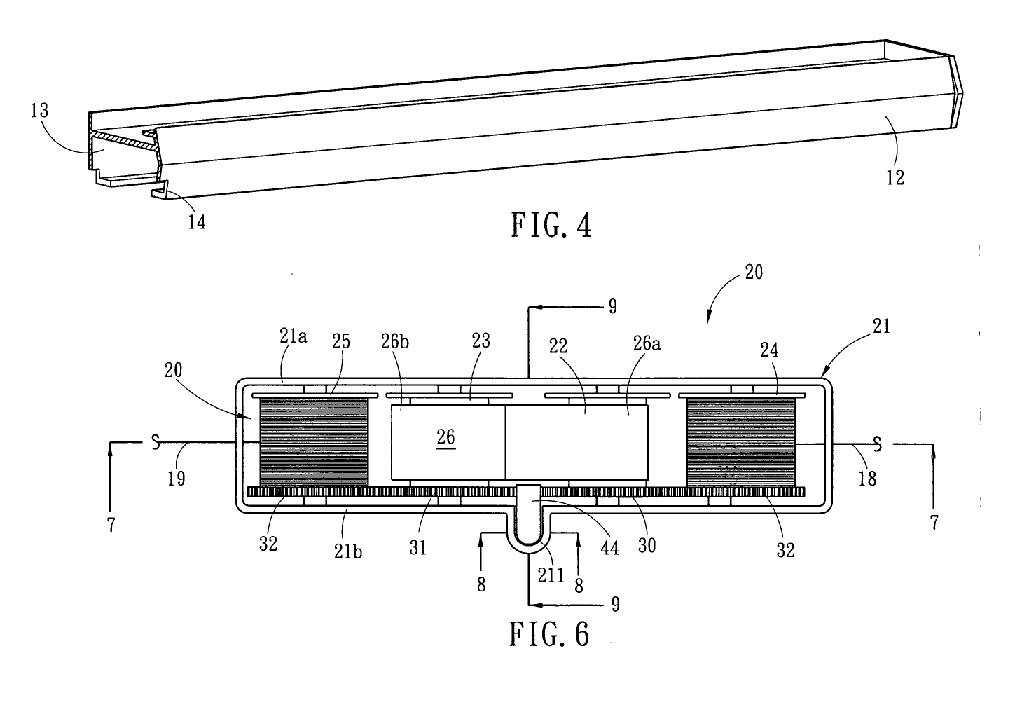

Referring to FIGS. 2 to 4, a blind 10 incorporating a preferred embodiment of tension means 20 according to the invention is shown. The blind 10 comprises a hollow head rail 11, a hollow bottom rail 12 including a transverse channel 13 and an opening 14 open to the channel 13, and a sheet of drapery material 15 coupled between the head rail 11 and the bottom rail 12. The sheet of drapery material 15 is implemented as a folding one, slats of Venetian blind, or slats of roll-up blind. In the embodiment, the sheet of drapery material 15 is a folding one. The sheet of drapery material 15 comprises a plurality of folds 16 each having left and right orifices 17. Line 18 has one end fastened at the head rail 11 and the other end passed the left orifices 17 to couple to the tension means 20 provided in the channel 13 and line 19 has one end fastened at the head rail 11 and the other end passed the right orifices 17 to couple to the tension means 20 respectively as detailed later.

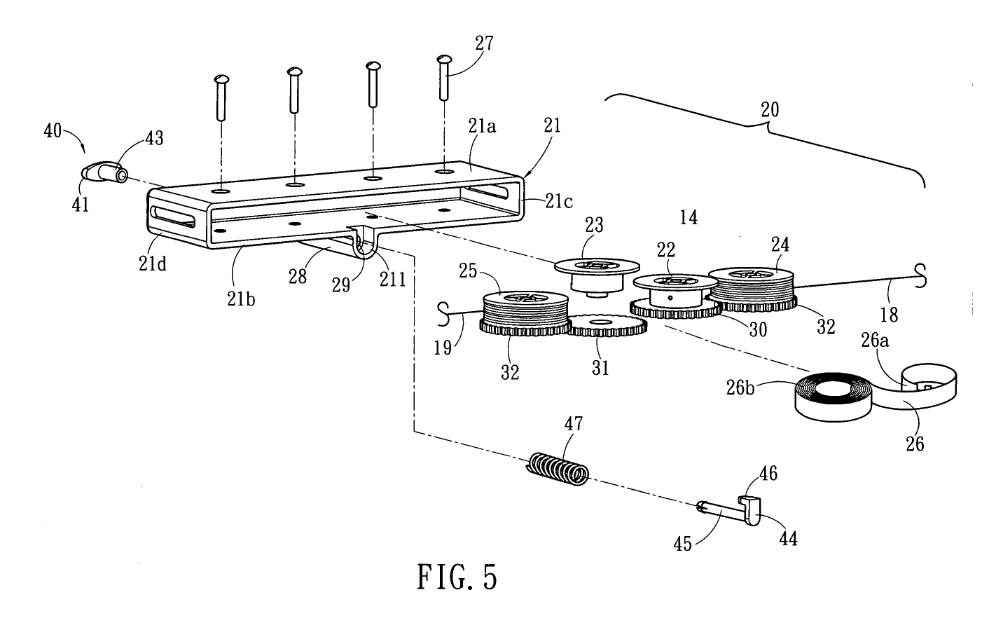

Referring to FIGS. 5 to 8, the tension means 20 comprises a substantially parallelepiped housing 21 including a top 21a, a bottom 21b, and two sides 21c and 21d. The tension means 20 further comprises an output drum 22, a storage drum 23, and two cord reels 24 and 25 all mounted in the housing 21. One cord reel 24 is provided proximate one side 21c. The other end of line 18 is wound on one cord reel 24 after passing an opening on the side 21c. Similarly, the other end of line 19 is wound on the other cord reel 25 after passing an opening on the side 21d. The output drum 22, the storage drum 23, and the cord reels 24 and 25 are spaced each other. Each of a plurality of axes 27 is vertically inserted through the top 21a, one of the output drum 22, the storage drum 23, and the cord reels 24 and 25, and the bottom 21b such that each of the output drum 22, the storage drum 23, and the cord reels 24 and 25 may turn on its axis 27.

The tension means 20 further comprises an S-shaped tape spring 26 interconnected the output drum 22 and the storage drum 23 for providing a counterbalancing force or tension. The tape spring 26 has one end 26a fastened on the output drum 22 and the other end 26b fastened on the storage drum 23 in which most portions of the spring 26 are wound on the storage drum 23. Rotation direction of the turning storage drum 23 is opposite to that of the turning cord reel 24 or 25.

The output drum 22 comprises a bottom gear 30, the storage drum 23 comprises a bottom idler gear 31, and each of the cord reels 24 and 25 comprises a bottom gear 32. All gears are disposed proximate the bottom 21b. One gear 32 is meshed with the idler gear 31 which is in turn meshed with the gear 30. The gear 30 is again meshed with the other gear 32. All gears have the same diameter and the same number of teeth.

The tension means 20 further comprises a trigger mechanism 40 provided in the housing 21 within the bottom rail 21. A casing 28 is projected downward from the bottom 21b. The casing 28 comprises an inner bore 29 and an outer cavity 211 aligned with the bore 29. A neck 291 is formed between the bore 29 and the cavity 211 The trigger mechanism 40 comprises a push button 41 projected from the bottom rail 12, the push button 41 including an inward extending cylindrical socket 43 slidably fitted in the bore 29; and a lock assembly 44 including an inward extending bar 45 having one end fastened in the socket 43 after passing the bore 29 (i.e., the push button 41 and the lock assembly 44 being connected together as a unitary member), and a bent lock member 46 formed with the other end of the bar 45. The lock member 46 is provided between the output drum gear 30 and the idler gear 31. The lock member 46 is adapted to move to engage with both the output drum gear 30 and the idler gear 31 or not. The lock assembly 44 further comprises a helical spring 47 put on the bar 45 in the bore 29 and biased between the neck 291 and the socket 43. Thus, the lock assembly 44 is implemented as a spring biased assembly.

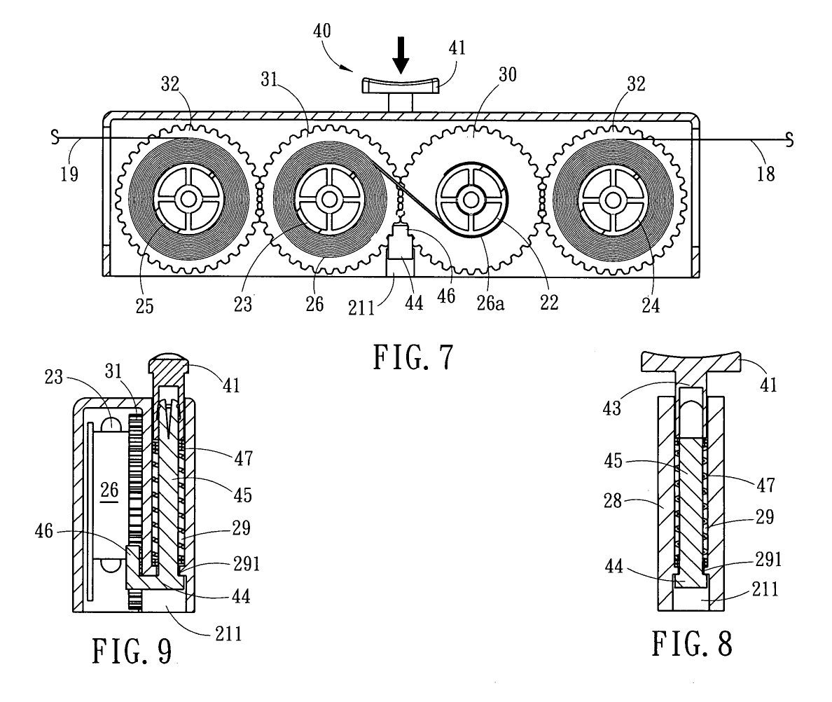

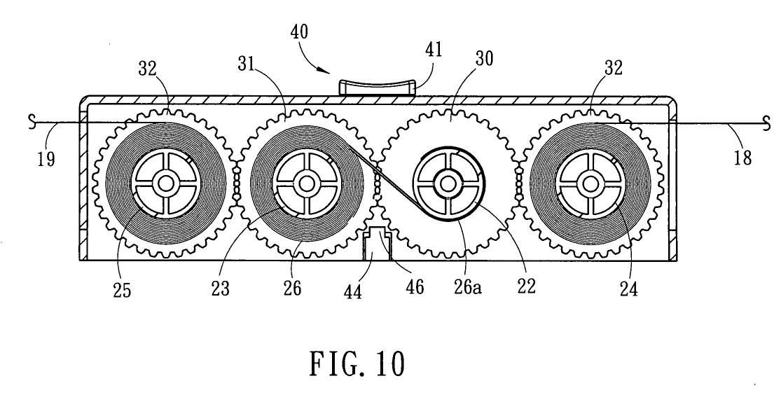

Referring to FIGS. 9 and 10 in conjunction with FIG. 7, the push button 41 is disposed distal the housing 21 in an inoperative state and the lock member 46 is sandwiched by the output drum gear 30 and the idler gear 31 (i.e., both the output drum gear 30 and the idler gear 31 are prohibited from turning). Thus, the bottom rail 21 stays at any one of a plurality of positions from a fully raised position to a fully lowered position. Pressing the push button 41 will push the lock assembly 44 (i.e., the lock member 46) to clear both the output drum gear 30 and the idler gear 31. Then, exert a minimum force on the bottom rail 12 to raise or lower the sheet of drapery material 15. As a result, the sheet of drapery material 15 stops and stays at a desired one of the plurality of positions from the fully raised position to the fully lowered position after releasing the force.

The tape spring 26 is energized in response to the pushing. Also, length of the tape spring 26 decreased on the output drum 22 is the same as that increased on the storage drum 23. The tape spring 26 is further energized by the weight of the sheet of drapery material 15. The socket 43 retracts into the bore 29 in response to the pushing with the spring 47 being compressed. The tension means 20 is free when the lock assembly 44 is not engaged with both the output drum gear 30 and the idler gear 31. As such, a person may manipulate the sheet of drapery material 15 to raise or lower and cause the sheet of drapery material 15 to stay at a desired position after releasing the pushing. Also, the push button 41 bounces back to its original position (i.e., distal the housing 21) and the lock member 46 is sandwiched by the output drum gear 30 and the idler gear 31 again (i.e., the blind is locked).

Referring to FIGS. 3 and 7 again, a person may raise the bottom rail 12 after pushing the push button 41. An upward force is thus exerted on the sheet of drapery material 15. The upward force together with the stored elastic force of the tape spring 26 is larger than the weight of the sheet of drapery material 15 (i.e., downward force). For balancing the upward force and the downward force, the tap spring 26 is adapted to unwind from the storage drum 23 and wind on the output drum 22 at the same time. This action may change torque exerted on each of the cord reels 24 and 25 and turn both the cord reels 24 and 25. As a result, line 18 is wound on the cord reel 24 and line 19 is wound on the cord reel 25 respectively. As stated above, the sheet of drapery material 15 stops and stays at a desired position after releasing the force. Alternatively, the person may lower the bottom rail 12 after pushing the push button 41. An downward force is thus exerted on the sheet of drapery material 15. The downward force together with the weight of the sheet of drapery material 15 is larger than an upward force of the lines 18 and 19 exerted by the energized tape spring 26. For balancing the upward force and the downward force, the tap spring 26 is adapted to wind on the storage drum 23 and unwind from the output drum 22 at the same time. This action may change torque exerted on each of the cord reels 24 and 25 and turn both the cord reels 24 and 25 in a direction opposite that in the upward movement of the sheet of drapery material 15. As a result, line 18 is unwound from the cord reel 24 and line 19 is unwound from the cord reel 25 respectively. As stated above, the sheet of drapery material 15 stops and stays at a desired position after releasing the force. While the invention herein disclosed has been described by means of specific embodiments, numerous modifications and variations could be made thereto by those skilled in the art without departing from the scope and spirit of the invention set forth in the claims.

What is claimed is:

1. A blind comprising:
a head rail;
a bottom rail;
a sheet of drapery material coupled between the head rail and the bottom rail;
tension means provided in the bottom rail and including an intermediate output drum, an intermediate storage drum, a first cord reel at one side proximate the output drum, a second cord reel at the other sides proximate the storage drum, and an S-shaped tape spring interconnected the output drum and the storage drum for providing a counterbalancing force or tension;
a couple of lines either interconnected the head rail and the bottom rail by passing the sheet of drapery material wherein a portion of either line is wound on either cord reel; and
a trigger mechanism provided in the bottom rail and including a lock member disposed between the output drum and the storage drum;
wherein the lock member is adapted to move either in a first direction to engage with both the output drum and the storage drum for locking the output drum, the storage drum, and the first and second cord reels or in a second direction opposite the first direction to disengage with both the output drum and the storage drum for permitting the output drum, the storage drum, and the first and second cord reels to turn for either winding the lines to raise the sheet of drapery material or unwinding the lines to lower the sheet of drapery material.

2. The blind of claim 1, wherein the tension means further comprises a housing for receiving the output drum, the storage drum, and the first and second cord reels, and wherein each of the output drum, the storage drum, and the first and second cord reels includes an axes having both ends secured to top and bottom of the housing.

3. The blind of claim 1, wherein a rotation direction of the turning storage drum is opposite to that of either one of the turning first and second cord reels.

4. The blind of claim 1, wherein the trigger mechanism further comprises a push button projected from the bottom rail, the push button connected to the lock member such that pushing the push button will disengage the lock member with both the output drum and the storage drum.

5. The blind of claim 2, wherein the output drum further comprises a first gear proximate the bottom of the housing the storage drum further comprises an idler gear proximate the bottom of the housing, and each of the first and second cord reels further comprises a second gear proximate the bottom of the housing, wherein the first gear is meshed with the idler gear, the idler gear is meshed with one second gear, and the first gear is meshed with the other second gear, and wherein the lock member is adapted to move to lockingly engage with both the first gear and the idler gear or not.

6. The blind of claim 4, further comprising a helical spring anchored between the push button and the lock member such that the lock member is adapted to resiliently move to lockingly engage with both the first gear and the idler gear by pushing the push button or not.

7. The blind of claim 5, wherein all of the first gear, the second gears, and the idler gear have the same diameter and the same number of teeth.
